(19) United States
(12) Patent Application Publication
(10) Pub. No.: US 2023/0199720 A1
(43) Pub. Date: Jun. 22, 2023

(54) PRIORITY-BASED JOINT RESOURCE ALLOCATION METHOD AND APPARATUS WITH DEEP Q-LEARNING

(71) Applicant: Industry-Academic Cooperation Foundation, Chosun University, Gwangju (KR)

(72) Inventors: Wooyeol CHOI, Gwangju (KR); Sifat Rezwan, Gwangju (KR)

(73) Assignee: Industry-Academic Cooperation Foundation, Chosun University, Gwangju (KR)

(21) Appl. No.: 18/055,687

(22) Filed: Nov. 15, 2022

(30) Foreign Application Priority Data
Dec. 17, 2021 (KR) 10-2021-0181564

(51) Int. Cl. H04W 72/02; H04W 72/04; H04W 72/10

(52) U.S. Cl. CPC H04W 72/02; H04W 72/0473; H04W 72/10

(57) ABSTRACT

Provided are resource allocation method and apparatus. The resource allocation method according to an embodiment may include allocating power to at least one device; determining a priority of the at least one device; and learning a sum-rate (data rate) according to channel allocation using Q-learning, and allocating a channel to the at least one device based on the learned content.

### CROSS-REFERENCE TO RELATED APPLICATIONS

This application claims the priority of Korean Patent Application No. 10-2021-0181564 filed on Dec. 17, 2021, in the Korean Intellectual Property Office, the disclosure of which is incorporated herein by reference.

### BACKGROUND OF THE INVENTION

### Field of the Invention

The present disclosure relates to priority-based joint resource allocation method and apparatus, and more particularly, to priority-based joint resource allocation method and apparatus with deep Q-learning.

### Description of the Related Art

With the rapid increase in the popularity of the Internet of Things (IoT) and cloud computing, the demand for high-reliability data rates and large-scale connections for wireless communication networks is gradually increasing.

To meet these needs, the 3rd Generation Partnership Project (3GPP) has introduced a fifth-generation (5G) wireless network that provides three main services. Main services for the 5G wireless network include massive machine type communication (mMTC) for supporting large-scale connection for IoT devices, enhanced mobile broadband (eMBB) for providing high data rates for mobile platforms, ultra-reliable and low-latency communication (URLLC) for ensuring low latency and reliability for highly sensitive and critical applications, and the like.

These services may be classified in terms of quality-of-service (QoS), and the URLLC has a strict QoS policy for high reliability and low latency, the eMBB service has a medium QoS policy, but the mMTC has no specific QoS policy except for a large-scale connection.

The QoS policy is difficult to be performed with conventional orthogonal multiple access (OMA) due to limited spectrum resources, large transmission loss, and long latency delay. Therefore, in order to maintain various QoS requirements, many technologies have been introduced into the 5G communication network, and among them, non-orthogonal multiple access (NOMA) is increasing in popularity by supporting large-scale connections with limited resources, very stable transmission, low transmission delay and high spectral efficiency.

However, the NOMA system has problems with resource allocation including power allocation and channel allocation. For example, all combinations capable of channel allocation and power allocation require reaching an optimal solution, which complicates a system and requires extremely high computation ability. In particular, in the case of a multi-carrier NOMA system, the system may become more complex.

Since an increase in a system sum-rate does not necessarily increase a channel sum-rate of each channel, another problem of the multi-carrier NOMA is the fairness of the channel sum-rate. A poor sum-rate of all channels may degrade the performance of a device allocated to the corresponding channel.

In addition, complete signal decoding using successive interference cancellation (SIC) and meeting QoS requirements for 5G services also depend on power allocation and channel allocation. Incomplete SIC and improper channel allocation may easily degrade the overall performance of the system.

The above-described technical configuration is the background art for helping in the understanding of the present invention, and does not mean a conventional technology widely known in the art to which the present invention pertains.

### SUMMARY OF THE INVENTION

The present disclosure has been created to solve the above-described problems, and an object of the present disclosure is to provide resource allocation method and apparatus using a priority-based deep learning model.

The objects of the present disclosure are not limited to the aforementioned objects, and other objects, which are not mentioned above, will be apparent to those skilled in the art from the following description.

According to an embodiment of the present disclosure, there is provided a resource allocation method in a non-orthogonal multiple access system including: (a) allocating power to at least one device; (b) determining a priority of the at least one device; and (c) learning a sum-rate (data rate) according to channel allocation using Q-learning, and allocating a channel to the at least one device based on the learned content.

The resource allocation method according to another embodiment may include (d) setting a channel-to-noise ratio of the device as a state, a channel allocation as an action, and a sum-rate for the channel as a reward, respectively, with respect to the state, the action, and the reward of the Q-learning; (e) allocating a channel using a deep neural network (DNN) based on a current state; (f) acquiring the sum-rate for the channel and next state information; and (g) determining a channel allocation policy while repetitively performing steps (e) and (f).

In another embodiment, power may be allocated to at least one device based on the sum-rate.

In yet another embodiment, the sum-rate may be a rate calculated by summing data rates of each device for the channel.

In another embodiment, the allocating of the power may be allocating the power to a predetermined threshold value or more.

In another embodiment, the priority may be determined based on communication quality requirements required for the at least one device.

In yet another embodiment, the priority may also be determined based on a distance between the at least one device and a base station.

In an embodiment, the at least one device may include at least one of an enhanced mobile broadband (eMBB) device, a massive machine type communication (mMTC) device, and an ultra-reliable and low-latency communication (URLLC) device.

According to an embodiment of the present disclosure, there is provided a resource allocation apparatus in a non-orthogonal multiple access system including: an allocation unit configured to determine a priority of at least one device and allocate power and channels; and a Q-learning unit configured to learn a sum-rate (data rate) according to the channel allocation using Q-Learning, and determine a channel allocation policy so that the sum-rate is greater than or equal to a predetermined value based on the learned content.

In another embodiment, the Q-learning unit may calculate a difference between a Q*-value calculated by a target DNN and a Q-value calculated by a policy DNN using a categorical cross-entropy loss function, and updates the policy DNN using an Adam optimizer.

In yet another embodiment, the Q-learning unit may set a channel-to-noise ratio of the device as a state, a channel allocation as an action, and a sum-rate for the channel as a reward, respectively, with respect to the state, the action, and the reward of the Q-learning, allocate a channel using a deep neural network (DNN) based on a current state, and determine a channel allocation policy by acquiring the sum-rate for the channel and next state information.

According to an embodiment of the present disclosure, there is provided a computer program, stored in a machine-readable non-transitory recording medium, comprising instructions implemented to perform the method of any one of claims 1 to 8, by means of a computer device.

Specific matters for achieving the above objects will be apparent with reference to embodiments to be described below in detail together with the accompanying drawings.

However, the present disclosure is not limited to embodiments to be disclosed below, but may be configured in various different forms, and will be provided to make the disclosure of the present disclosure complete and fully notify the scope of the present disclosure to persons with ordinary skill in the art to which the inventions pertain (hereinafter, “those skilled in the art”).

According to the embodiment of the present disclosure, it is possible to obtain an optimal resource allocation method with a large sum-rate by allocating channels using Q-learning.

In addition, according to the embodiment of the present disclosure, the Q-learning model increases resource allocation efficiency while performing unsupervised iterative learning by using a DNN.

The effects of the present disclosure are not limited to the above-described effects, and it will be understood that provisional effects toe expected by technical features of the present disclosure will be apparent from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and other advantages of the present invention will be more clearly understood from the following detailed description taken in conjunction with the accompanying drawings, in which:

FIG. 1 illustrates a NOMA system according to an embodiment;

FIG. 2 illustrates a single input single output (SISO)-NOMA system according to an embodiment;

FIG. 3 illustrates an example of allocating channels to a 3-device NOMA system;

FIG. 4 is a Q-learning schematic diagram according to an embodiment;

FIG. 5 illustrates a DNN structure according to an embodiment;

FIG. 6 illustrates an autoencoder according to an embodiment;

FIG. 7 illustrates an LSTM cell according to an embodiment;

FIG. 8 illustrates a DQL framework according to an embodiment;

FIG. 9 illustrates an algorithm of the DQL framework according to an embodiment;

FIG. 10 illustrates a priority-based resource allocation method with deep Q-learning according to an embodiment; and

FIG. 11 illustrates a priority-based resource allocation apparatus with deep Q-learning according to an embodiment.

### DETAILED DESCRIPTION OF THE PREFERRED EMBODIMENT

The present disclosure may have various modifications and various embodiments and specific embodiments will be illustrated in the drawings and described in detail.

Various features of the invention disclosed in the appended claims will be better understood in consideration of the drawings and the detailed description. Apparatuses, methods, manufacturing methods and various embodiments disclosed in the specification will be provided for illustrative purposes. The disclosed structural and functional features are intended to allow those skilled in the art to be specifically implemented in various embodiments, but are not intended to limit the scope of the invention. The disclosed terms and sentences are intended to be easily explained to the various features of the disclosed invention, but are not intended to limit the scope of the invention.

In describing the present disclosure, the detailed description of related known technologies will be omitted if it is determined that they unnecessarily make the gist of the present disclosure unclear.

Hereinafter, priority-based resource allocation method and apparatus with deep Q-learning according to an embodiment of the present disclosure will be described.

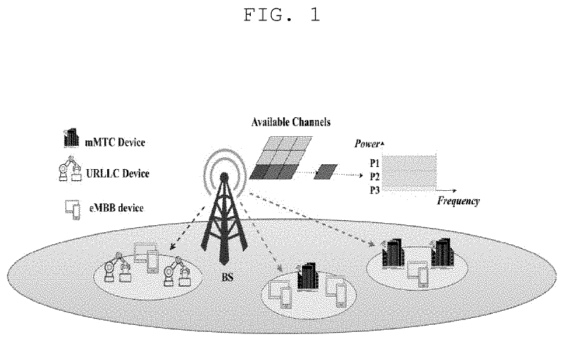

FIG. 1 illustrates a NOMA system according to an embodiment.

The NOMA system may provide services to many devices using the same radio resource block (RRB) using a power domain for both uplink and downlink transmissions. In a simple downlink multi-carrier NOMA system, a base station BS serves different types of devices simultaneously over a radio channel.

FIG. 1 illustrates a scenario of a 5G network consisting of three different devices. The base station allocates one channel for every three devices, and here, signals of the three devices are multiplexed at different power levels. Accordingly, these devices receive the signals of other two devices on the corresponding channel as noise or interference together with a desired signal. If the power level of the desired signal is high, an undesired signal acts as noise, and otherwise, the undesired signal acts as interference.

To decode the desired signal, each device uses a successive interference cancellation (SIC) technique. The SIC decodes the signal with the highest power and removes the corresponding signal from a main signal until the desired signal is decoded. Complete SIC depends on channel state information (CSI) such as a signal to interference plus noise ratio (SINR) , and the SINR depends on channel allocation and power allocation. In this case, a data rate of each device for the channel may be calculated using Equation 1 below.

$$\text{?}$$

$$\text{?} \text{indicates text missing or illegible when filed}$$

Here, Γ represents a channel-to-noise ratio (CNR) for an allocated channel k, and P represents allocated power.

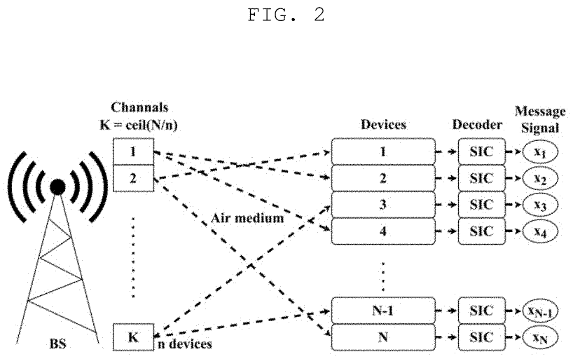

FIG. 2 illustrates a micro-cell of a 5G network consisting of a base station and a device capable of supporting 5G according to an embodiment. More specifically, FIG. 2 illustrates a downlink of a single-input and single-output (SISO) NOMA system in which the total number of devices is N and the number of channels is K.

FIG. 2 illustrates three types of devices requesting services of different 5G networks. Specifically, there are eMBB devices UE₁, UE₂, . . . , UEₑ, URLLC devices UL₁, UL₂, . . . , ULₗ, and mMTC devices MC₁, MC₂, . . . , MCₘ.

Illustratively, as not limited, it is assumed that a total available bandwidth BWₜ is divided into all channels having a channel bandwidth BW_{ch} of 180 kHz. The maximum number of devices per channel is n, the range of n is 2≤n≤N, the total number of channels is K, and K=ceil (N/n).

According to an embodiment, complete channel state information (CSI) is assumed, but incomplete CSI is also assumed in consideration of an actual radio environment.

If a k-th channel is allocated to n devices, wherein the power allocated to an n-th device is Pₙ and a desired signal of the n-th device is xₙ. After combining the signals of n devices, the base station transmits a signal expressed in Equation 2 below through the k-th channel.

$$\text{?} \qquad [ Equation 2 ]$$

$$\text{?} \text{indicates text missing or illegible when filed}$$

The signal transmitted from the device end reaches a path loss component and additive white Gaussian noise (AWGN). The reached signal may be expressed as Equation 3 below.

$$\text{?} \qquad [ Equation 3 ]$$

$$\text{?} \text{indicates text missing or illegible when filed}$$

Here, h^{k}ᵢ represents a channel gain of an i-th device, wₖ represents additional white Gaussian noise (AWGN), and the AWGN may include a temperature noise power distribution σₖ.

After receiving the signal, a receiver decodes the signal using the SIC technique. The complete SIC depends on a device SINR of the corresponding channel used for communication. It is assumed that the CNR of the n-th device for the k-th channel is as follows.

$$\text{?} \qquad [ Equation 4 ]$$

$$\text{?} \text{indicates text missing or illegible when filed}$$

As described above, different power levels may be allocated to devices in the channels. According to NOMA, the highest power is allocated to a device with the lowest CNR is allocated and vice versa. For example, in the case of a device having CNR of Γ^{k}₁>Γ^{k}₂> . . . >Γ^{k}ₙ, the power is allocated to P^{k}₁<P^{k}₂< . . . <P^{k}ₙ, respectively. Accordingly, the SINR and the data rate for each device of a specific channel may be expressed by Equation 5 and Equation 1 described above, respectively.

$$\text{?} \qquad [ Equation 5 ]$$

$$\text{?} \text{indicates text missing or illegible when filed}$$

In order to perform complete SIR, the base station allocates power to each device having a specific threshold Pₜₕ or more as illustrated in Equation 6 below. For example, a device with a low CNR needs to have higher power than the sum of the power of other devices with a high CNR to perfectly complete the SIR technique.

$$\text{?} \qquad [ Equation 6 ]$$

$$\text{?} \text{indicates text missing or illegible when filed}$$

Each device has a set Γ_{N}={Γ¹_{N}, Γ²_{N}, . . . , Γ^{k}_{N}} of channels for channel allocation and a power range P_{N} ∈[0.01, 0.99]×P_{T}, wherein P_{T} is a total power budget per channel for power allocation. In one embodiment, the device focuses on a sum-rate, which is a key performance indicator for optimizing the channel allocation and power allocation of the NOMA system.

$$\text{?} \qquad [ Equation 7 ]$$

$$\text{?} \text{indicates text missing or illegible when filed}$$

A minimum data rate requirement of all devices may be expressed as Equation 8 below.

$$\text{?} \qquad [ Equation 8 ]$$

$$\text{?} \text{indicates text missing or illegible when filed}$$

The sum of power per device of the channel needs to be smaller than or equal to P_{T}, and may be expressed as Equation 9 below.

$$\text{?} \qquad [ Equation 9 ]$$

$$\text{?} \text{indicates text missing or illegible when filed}$$

Hereinafter, in order to derive an optimal power allocation method and ensure fairness between devices and system performance improvement, a priority-based channel allocation method will be described using a deep Q-learning (DQL) algorithm to maintain QoS of 5G service, maximizing sum-rate (MSR), and maximizing channel sum-rate (MCSR). Specifically, since the DQL requires power allocation to evaluate channel allocation and train DNN, a power allocation solution for a given channel is first described, and then a DQL framework for priority-based channel allocation will be described to obtain an optimal solution for the NOMA system.

Optimal power allocation for a given channel will be described in order to increase maximum sum-rate and system efficiency while considering various constraints of the NOMA according to an embodiment. Illustratively, the devices may be sorted in descending order according to a distance from the base station. Since the main purpose is to maximize the sum-rate, a convex function for a given channel k is maximized in consideration of Equations 6, 8, and 9, which may be expressed as Equation 7, and may be formulated as Equation 10 below.

$$\text{?} \qquad [ Equation 10 ]$$

$$\text{?} \text{indicates text missing or illegible when filed}$$

A convex problem of Equation 10 may also be expressed in a Lagrangian form as in Equation 11 below.

$$\text{?} \qquad [ Equation 11 ]$$

$$\text{?} \text{indicates text missing or illegible when filed}$$

Here, τ, ν and ψ are Lagrange multipliers, ∀i=1, 2, . . . , n, and φ^{k}ᵢ=2^{Rki/KBWch}.

By differentiating Equation 11 with respect to Pi, τ, ν and ψ, multiple Karush-Kuhn-Tucker (KKT) conditions may be obtained. In the case of NOMA with n devices, there are 2n Lagrange multipliers, resulting in 22n combinations. For example, in the case of n=2, 3, 4, . . . , 8, the number of combinations is 16, 64, 256, . . . , 65536, respectively. However, it is not computationally possible to identify all types of combinations. Accordingly, if only n equations are solved for NOMA having 2, 3, and 4 devices, 2, 4, and 8 combinations that satisfy the KKT condition may be found, respectively. Therefore, a closed solution of power allocation for NOMA with n devices for a given channel k is almost optimal, and may be expressed as Equation 12 below.

$$\text{?} \qquad [ Equation 12 ]$$

$$\text{?} \text{indicates text missing or illegible when filed}$$

Here, x=1, 2 and j=3, 4, . . . , n, and q=0, 1, . . . , (n−3). In addition, the devices have CNRs of Γ^{k}₁>Γ^{k}₂> . . . >Γ^{k}ₙ together with power of P^{k}₁<P^{k}₂< . . . <P^{k}ₙ, respectively.

Hereinafter, a priority-based channel allocation method using DQL according to an embodiment will be described in more detail.

It will be described an autoencoder according to an LSTM network for formulating channel assignment problem based on maximizing sum-rate (MSR), maximizing channel sum-rate (MCSR), and priority, modeling the channel assignment problem as a reinforcement task and generating a DQL framework. Finally, DNN learning for validation using a near-optimal power allocation solution will be described.

The 5G wireless network provides three services with different QoS requirements. The URLLC service has the highest QoS requirements, the eMBB service has average QoS requirements, and the mMTC service has the lowest QoS requirements. Accordingly, the priority of the network device may be assigned based on the services in use and QoS requirements, and the URLLC service has the highest priority, the eMBB service has the second higher priority, and the mMTC service has the lowest priority.

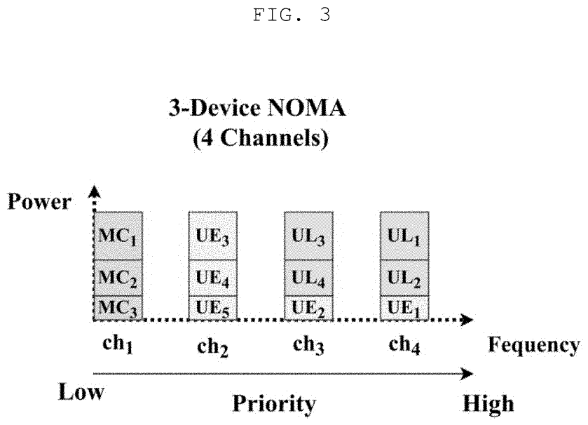

The base station sorts the URLLC, eMBB and mMTC devices in descending order according to a distance from the base station. Next, the base station may allocate the URLLC device to a channel having the highest gain and allocate the eMBB device and the mMTC device according to available channels as illustrated in FIG. 3.

Specifically, FIG. 3 illustrates priority-based channel allocation of a 3-type NOMA system with four URLLCs, five eMBBs, and three mMTC devices. The channel allocation method illustrated in FIG. 3 is illustrative and may vary according to a CNR of each device with the base station.

Another main requirement of channel allocation optimization is to maximize the channel and overall sum-rate. The base station has a combination of

$$\text{?}$$

$$\text{?} \text{indicates text missing or illegible when filed}$$

for confirming whether to maximize the sum-rate for each channel k. Accordingly, the overall combination is generally

$$\text{?}$$

$$\text{?} \text{indicates text missing or illegible when filed}$$

for MCSR. For the priority, a low priority device cannot replace a high priority device in a channel. However, a high or equal priority device may replace an equal or low priority device in a given channel. A maximization process integrated with a priority scheme is computationally complex because the base station needs to confirm all possible combinations of devices. Therefore, the following describes DQL, which allocates channels to devices while maintaining priority and maximizing the sum-rate to reduce computational complexity.

In the DQL according to an embodiment, a priority-based channel allocation problem may be optimized. Specifically, the DQL algorithm generally consists of deep neural network (DNN) agent and environment. The agent interacts with the environment and determines an action to be taken. For example, abase station acts as an agent and interacts with an environment consisting of URLLC, eMBB and mMTC device information.

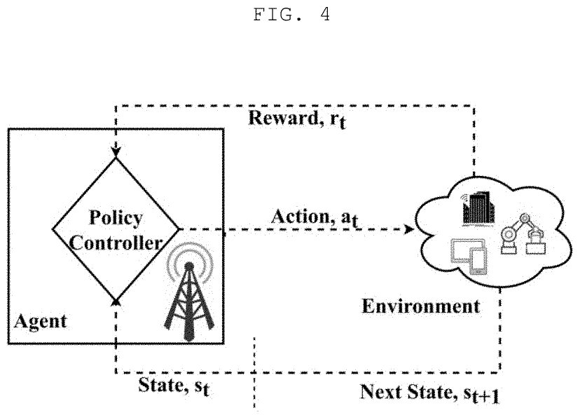

Initially, the agent starts searching for the environment to collect channel information of all devices. At each time step t, based on a current state sₜ of the agent in the environment, the agent predicts a action at when allocating a channel using the DNN. As a return value, the agent receives an immediate reward rₜ from the environment and a next state sₜ₊₁, as shown in FIG. 4. The agent receives a good reward rₜ when performing the channel allocation well. The agent learns about the environment by predicting the action and achieves an optimal channel allocation policy π_{c}. The optimal policy is learned by the DNN at each time step t. The agent repeats the channel allocation process for multiple episodes to update and improve the policy π_{c}. If there are no channels left to be allocated, an episode ends.

A state, an action, and a reward for use in the DNN according to an embodiment may be defined as follows.

1) State: Channel information for each device is defined as the state of the environment. With respect to N devices with K channel preferences, a state space has N×K elements and may be represented as S={Γ¹₁, Γ²₁, Γ³₁, . . . , Γ^{K}₁, Γ^{K}₂, Γ^{K}₃, . . . , Γ^{k}_{N}}.

2) Action: The main action of the agent is to allocate channels to devices belonging to an action space A. In each episode of set S, the agent needs to take N ∈ A actions, while maintaining one action per K elements from a set S. For example, with respect to a NOMA with 2, 3, . . . , n devices, the agent may perform one action 2, 3, . . . , n times.

3) Reward: Whenever the agent completes N actions, the agent receives a reward r¹ₜ for each action. For each correct action, the agent receives a positive reward rᵢ, and when the agent takes n correct actions, the agent obtains a sum-rate of the corresponding channel as a reward for the taking action. For example, NOMA with 3 devices is assumed. The agent needs to allocate three devices per channel. In this case, if the agent successfully selects an appropriate channel according to a priority of the device, the agent gets a positive reward rᵢ (i.e., 10). If the agent may select the same appropriate channel for three devices, the agent obtains the sum-rate calculated by Equation 1 as a reward for three tasks. In this case, a reward function may be defined as follows.

$$\text{?} \qquad [ Equation 13 ]$$

$$\text{?} \text{indicates text missing or illegible when filed}$$

Wherein, a^{k}ₚ represents the number of appropriate actions a^{l}ₜ taken per channel k, and ∀ₗ=1, 2, . . . , N ∈ A. The maximizing of the sum-rate for each channel, which increases the performance and fairness of the overall system will be described.

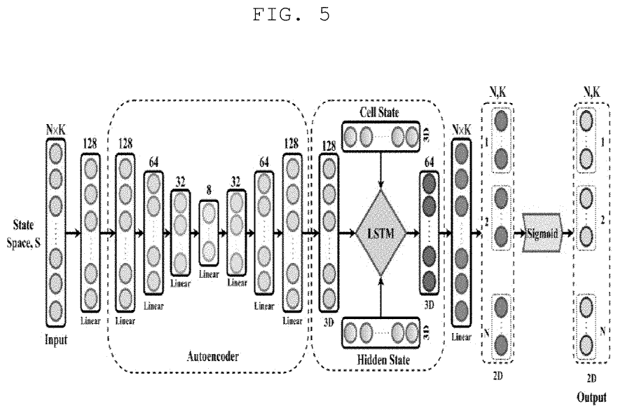

FIG. 5 illustrates a DNN structure as a policy controller for channel allocation with the state, the action and the reward. The DNN replaces a Q-Table and estimates a Q-value for each state-action pair in the environment. As a result, the DNN calculates an approximation to the optimal policy for channel allocation. The DNN according to an embodiment includes two parts: an autoencoder model and a long short-term memory (LSTM) model. The main goal of DNN is to derive a probability for each device-channel pair for each state space that can be expressed as Q(S, A). This probability is the Q-value for DQL.

The autoencoder according to an embodiment is a feed-forward neural network in which the number of inputs is equal to the number of output neurons. Specifically, the input is compressed into a low-dimensional code, and then input data is reconstructed from the code at the output end. The autoencoder may easily process raw input data without colorful processing or labeling. Therefore, the autoencoder is considered as a part of an unsupervised learning technique and may generate labels from training data.

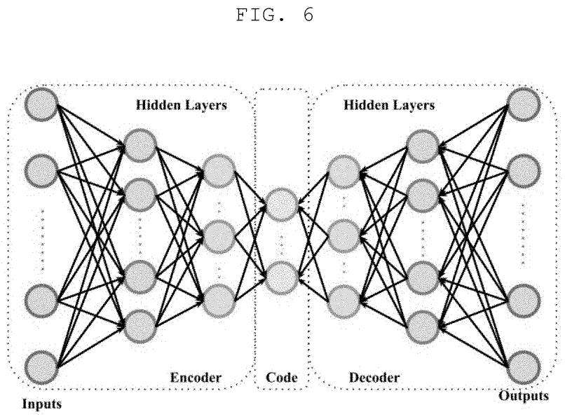

FIG. 6 illustrates an autoencoder. Illustratively, as not limited, the autoencoder may be composed of three main parts:

an encoder, a code, and a decoder. Both the encoder and the decoder are fully connected neural networks. The encoder starts from an input layer with 2ⁿ neurons, followed by multiple hidden layers with 2^{n-h} neurons. Here, h is a position of the layer. The number of neurons per hidden layer continues to decrease until a code part of the autoencoder. As an example, 2³ neurons are used for a code layer. The decoder has a mirror image symmetric structure of the encoder ending in the output layer. The above-described structure is a stacked autoencoder because layers are sequentially stacked like a sandwich. According to an embodiment, a rectified linear unit (ReLU) may be used as an activation function for each layer of the autoencoder.

A long-short term memory (LSTM) is an evolved form of a recurrent neural network (RNN). The LSTM is a special type of RNN capable of learning long-term dependency and memorizing previous information for future use.

The LSTM network has a chain structure consisting of several LSTM cells. An LSTM network constructed using three LSTM cells is assumed.

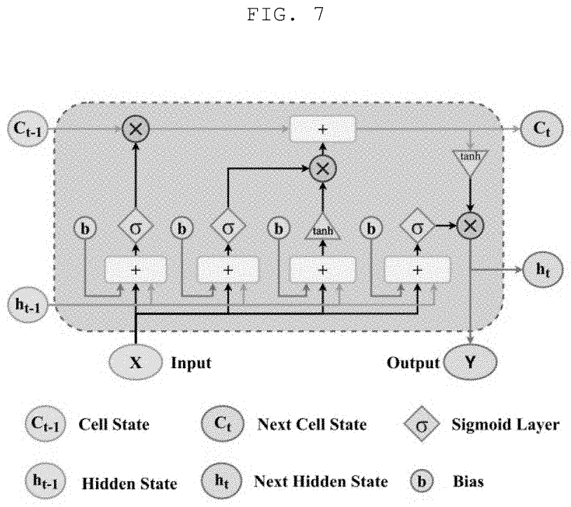

FIG. 7 illustrates a structure of a single LSTM cell. The LSTM cell according to an embodiment has three input parameters and two output parameters. The cell and the hidden state are common parameters between the input and the output. The other parameter is a current input. The LSTM cell may also include three Sigmoid layers and two hypertangent (tanh) layers including a linear transform as illustrated in FIG. 7. Initially, together with the input to the first LSTM cell, a random cell and a hidden state are given. Then, the two outputs (hidden state and cell state) become three inputs to the next cell.

In succession to the autoencoder with input and output sizes of 128 and a code size of 8, an LSTM network with an input size of 128, a hidden state size of 64, and a recurrent layer of 3, will be described as an example. Finally, the output of the LSTM passes through the linear and sigmoid layers to obtain a probability for a preferred channel of each device. The state space S is provided as an input to the policy network. Initially, the input is first included in a dimension of 128. Thereafter, as illustrated in FIG. 5, the input passes through the policy network to generate a channel allocation probability as illustrated in FIG. 5.

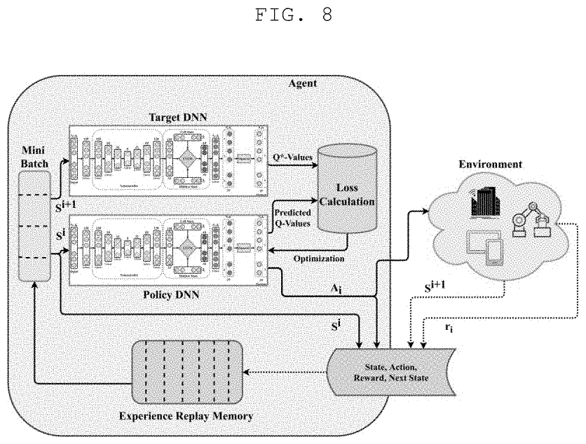

FIG. 8 illustrates a DQL framework according to an embodiment. The DQL framework according to an embodiment may include an agent and an environment. The agent may include a target DNN, a policy DNN, an experiential replay memory and a placement. Hereinafter, each configuration will be described in detail.

A DNN according to an embodiment is gradually trained using a training data set T_{data}={S¹, S², . . . , S^{ins}} every episode. For each state space S, a device-channel pair is selected using an ε-greedy policy according to the output probability from the DNN. An episode ends when all state spaces have passed through the DNN. A policy to take an action for each device by state space may be expressed as follows.

$$\text{?} \qquad [ Equation 14 ]$$

$$\text{?} \text{indicates text missing or illegible when filed}$$

∀ₗ=1, 2, . . . , N ∈ A,

∀ᵢ=1, 2, . . . , ins.

After performing the action using Equation 14, the agent receives a reward according to Equation 13 and the following state space Sⁱ⁺¹.

To train a DNN, a loss is calculated and parameters of the DNN to perform backpropagation are optimized. To calculate the loss, an optimal Q*-values for each device-channel pair of Sⁱ⁺¹ is approximated from another DNN called a target DNN. The target DNN is the same as the policy DNN and is initialized by the parameters of the policy DNN. The next state space Sⁱ⁺¹ is given as an input to the target DNN and an optimal Q*-value is greedily selected from the output by the agent. Since the channel allocation is a classification problem, a loss between an optimal Q* value and a normal Q value is calculated by using a categorical cross-entropy loss function. After the loss is calculated, the policy DNN is optimized using an Adam optimizer. In order to correctly estimate the optimal Q*-value, the target DNN is periodically updated with the parameters of the policy DNN after a specific episode.

For more stable convergence of the optimal policy, an experience replay memory (ERM) in DQL will be described. Initially, the agent searches the environment and stores a current state, an action, a reward and next states Sⁱ, Aᵢ, rᵢ, and Sⁱ⁺¹ as a tuple of the experiential replay memory. Next, the agent trains the policy DNN by fetching a mini-batch of the tuple from the experiential replay memory. The experiential replay memory is continuously updated for each training data.

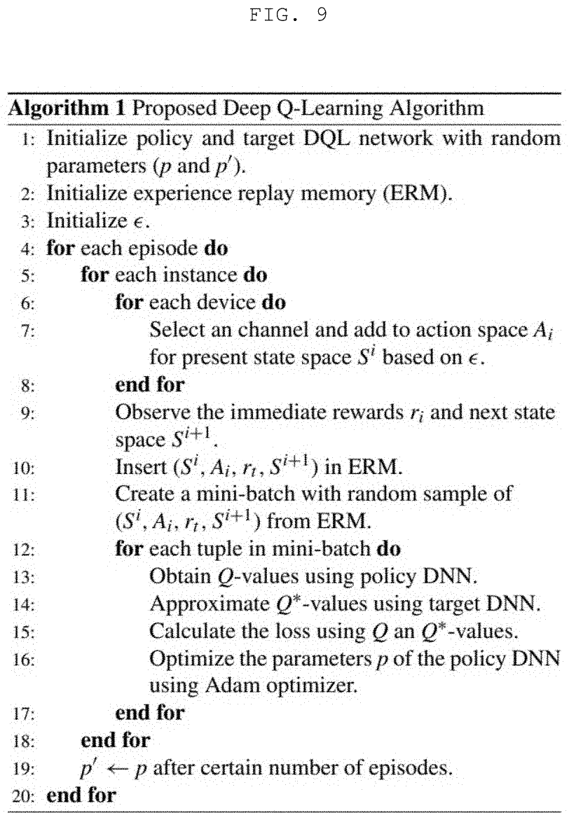

FIG. 9 illustrates an algorithm of the DQL framework. The algorithm of the DQL framework will be described in more detail.

The DQL framework according to an embodiment may include selecting a channel based on an epsilon and adding the selected channel to an action space Aᵢ for a current state space Sⁱ, observing a reward rᵢ and a next state space Sⁱ⁺¹; inputting (Sⁱ, Aᵢ, rᵢ, and Sⁱ⁺¹) to the experience replay memory (ERM) ; and generating a mini-batch with a random sample extracted from the experiential replay memory.

The generating of the mini-batch may include obtaining a Q value using a policy DNN for each tuple of the mini-batch; approximating a Q* value using the target DNN; calculating a loss using the Q and Q* values; and optimize a parameter p of the policy DNN using an Adam optimizer.

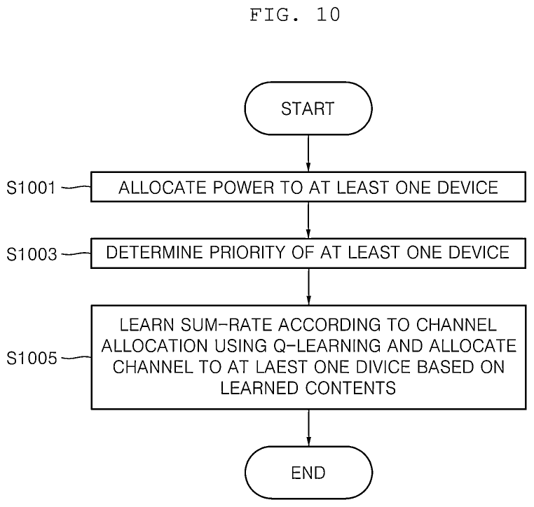

FIG. 10 illustrates a priority-based resource allocation method using deep Q-learning according to an embodiment. In an embodiment, in a method of allocating resources in a non-orthogonal multiple access system, each step of FIG. 10 may be performed by a base station.

Referring to FIG. 10, step S1001 is a step of allocating power to at least one device. In an embodiment, power may be allocated to at least one device based on a sum-rate.

In an embodiment, the sum-rate may be a rate calculated by summing a data rate of each device for a channel.

In an embodiment, in the allocating of the power, the power may be allocated as a predetermined threshold value or more.

Step S1003 is a step of determining the priority of the at least one device.

In an embodiment, the priority may be determined based on communication quality requirements required for at least one device. In an embodiment, the priority may be determined based on a distance between the at least one device and the base station.

In an embodiment, the at least one device may include at least one of an enhanced mobile broadband (eMBB) device, a massive machine type communication (mMTC) device, and an ultra-reliable and low-latency communication (URLLC) device.

Step S1005 is a step of learning a sum-rate (data rate) according to channel allocation using Q-learning, and allocating a channel to the at least one device based on the learned content.

In an embodiment, the channel allocation policy may be determined by repetitively performing a step of setting the CRT of the device as a state, the channel allocation as an action, and the sum-rate for the channel as a reward, respectively, with respect to the state, the action, and the reward of the

Q-learning, allocating a channel using a deep neural network (DNN) based on a current state, acquiring a sum-rate for the channel and next state information, and allocating the channel using the DNN based on the current state and a step of acquiring the sum-rate for the channel and the next state information.

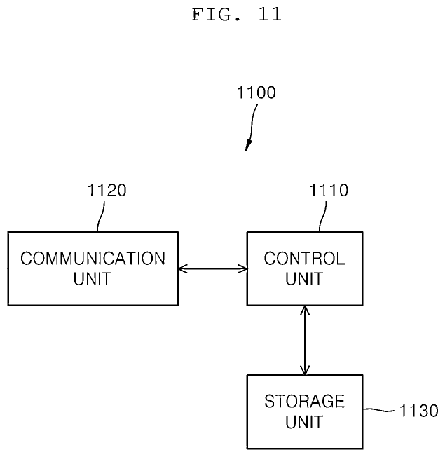

FIG. 11 illustrates a priority-based resource allocation apparatus using deep Q-learning according to an embodiment. In an embodiment, in an apparatus of allocating resources in a non-orthogonal multiple access system, a resource allocation apparatus 1100 of FIG. 11 may include a base station.

Referring to FIG. 11, the resource allocation apparatus 1100 may include a control unit 1110, a communication unit 1120, and a storage unit 1130.

The controller 1110 may determine a priority of at least one device and allocate power and a channel.

In an embodiment, the controller 1110 learns a sum-rate (data rate) according to the channel allocation using Q-Learning, and determine a channel allocation policy so that the sum-rate is greater than or equal to a predetermined value based on the learned content.

In an embodiment, the control unit 1110 may include at least one processor or microprocessor, or a part of the processor. Further, the control unit 1110 may be referred to as a communication processor (CP). The control unit 1110 may control the operation of the resource allocation apparatus 1100 according to various embodiments of the present disclosure.

The communication unit 1120 may transmit information on a channel allocated to at least one device.

In an embodiment, the communication unit 1120 may include at least one of a wired communication module and a wireless communication module. All or a part of the communication unit 1120 may be referred to as a ‘transmitter’, ‘receiver’, or ‘transceiver’.

The storage unit 1130 may store a channel allocation policy.

In an embodiment, the storage unit 1130 may be configured in a volatile memory, a non-volatile memory, or a combination of the volatile memory and the non-volatile memory. In addition, the storage unit 1130 may provide data stored according to the request of the control unit 1110.

Referring to FIG. 11, the resource allocation apparatus 1100 may include the control unit 1110, the communication unit 1120, and the storage unit 1130. In various embodiments of the present disclosure, since the components described in FIG. 11 are not required, the resource allocation apparatus 1100 may be implemented with more components or less components than the components described in FIG. 11.

The above description is just illustrative of the technical idea of the present disclosure, and various changes and modifications can be made within the scope without departing from the essential characteristics of the present disclosure.

Therefore, the embodiments of the present disclosure are provided for illustrative purposes only but not intended to limit the technical concept of the present disclosure. The scope of the technical concept of the present disclosure is not limited thereto.

The protective scope of the present disclosure should be construed based on the following claims, and all the techniques in the equivalent scope thereof should be construed as falling within the scope of the present disclosure.

What is claimed is:

1. A resource allocation method in a non-orthogonal multiple access system, comprising the steps of:
(a) allocating power to at least one device;
(b) determining a priority of the at least one device; and
(c) learning a sum-rate (data rate) according to channel allocation using Q-learning, and allocating a channel to the at least one device based on the learned content.

2. The resource allocation method of claim 1, wherein step (c) comprises
(d) setting a channel-to-noise ratio of the device as a state, a channel allocation as an action, and a sum-rate for the channel as a reward, respectively, with respect to the state, the action, and the reward of the Q-learning;
(e) allocating a channel using a deep neural network (DNN) based on a current state;
(f) acquiring the sum-rate for the channel and next state information; and
(g) determining a channel allocation policy while repetitively performing steps (e) and (f).

3. The resource allocation method of claim 1, wherein in step (a),
the power is allocated to at least one device based on the sum-rate.

4. The resource allocation method of claim 3, wherein the sum-rate is a rate calculated by summing data rates of each device for the channel.

5. The resource allocation method of claim 3, wherein the allocating of the power is allocating the power to a predetermined threshold value or more.

6. The resource allocation method of claim 1, wherein in step (b),
the priority is determined based on communication quality requirements required for the at least one device.

7. The resource allocation method of claim 1, wherein in step (b),
the priority is determined based on a distance between the at least one device and a base station.

8. The resource allocation method of claim 2, wherein the at least one device includes at least one of an enhanced mobile broadband (eMBB) device, a massive machine type communication (mMTC) device, and an ultra-reliable and low-latency communication (URLLC) device.

9. A resource allocation apparatus in a non-orthogonal multiple access system, comprising:
an allocation unit configured to determine a priority of at least one device and allocate power and channels; and
a Q-learning unit configured to learn a sum-rate (data rate) according to the channel allocation using Q-Learning, and determine a channel allocation policy so that the sum-rate is greater than or equal to a predetermined value based on the learned content.

10. The resource allocation apparatus of claim 9, wherein the Q-learning unit
calculates a difference between a Q*-value calculated by a target DNN and a Q-value calculated by a policy DNN using a categorical cross-entropy loss function, and updates the policy DNN using an Adam optimizer.

11. The resource allocation apparatus of claim 9, wherein the Q-learning unit
sets a channel-to-noise ratio of the device as a state, a channel allocation as an action, and a sum-rate for the channel as a reward, respectively, with respect to the state, the action, and the reward of the Q-learning,
allocates a channel using a deep neural network (DNN) based on a current state, and determines a channel allocation policy by acquiring the sum-rate for the channel and next state information.

12. A computer program, stored in a machine-readable non-transitory recording medium, comprising instructions implemented to perform the method of claim 1, by means of a computer device.
